(19) United States
(12) Patent Application Publication
(10) Pub. No.: US 2017/0032276 A1
(43) Pub. Date: Feb. 2, 2017

(54) DATA FUSION AND CLASSIFICATION WITH IMBALANCED DATASETS

(71) Applicant: AGT International GmbH, Zurich (CH)

(72) Inventors: Sergey SUKHANOV, Darmstadt (DE); Andreas MERENTITIS, Darmstadt (DE); Christian DEBES, Darmstadt (DE)

(21) Appl. No.: 14/811,863

(22) Filed: Jul. 29, 2015

(51) Int. Cl. G06N 99/00; G06F 17/30

(52) U.S. Cl. CPC G06N 99/005; G06F 17/30598

(57) ABSTRACT

Method and system for classification in imbalanced datasets within a supervised classification framework. Bootstrap methodology is modified according to k-Nearest Neighbor sampling weights and adaptive target set size principle, to induce weak classifiers from the bootstrap samples in an iterative procedure that results in a set of weak classifiers. A weighted combination scheme is used to adaptively combine the weak classifiers to a strong classifier that achieves good performance for all classes (reflected as high values for metrics such as G-mean and F-score) as well as good overall accuracy.

### BACKGROUND

Classification and data fusion tasks are usually formulated as supervised data processing problems, where, given training data of a dataset supplied to a processing engine, the goal is for the processing engine to learn an algorithm for classifying new data of the dataset. Training data involves samples belonging to different classes, where the samples of one class are often heavily underrepresented compared to the other classes. That is, dataset classes are often imbalanced. Class imbalance usually impacts the accuracy and relevance of training, which in turn degrades the performance of classification and data fusion algorithms that results from the training.

Training data typically includes representative data annotated with respect to the class to which the data belongs. For example, in face recognition, training data could include image detections associated with the respective individual identifications. In another example, aggression detection training data could include video and audio samples associated with a binary “yes/no” (“aggression/no agression”) as ground truth.

In many real-life applications training sets are imbalanced. This is particularly true in data fusion/classification applications where the aim is to detect a rare event such as aggression, intrusion, car accidents, gunshots, etc. In such applications it is relatively easy to get training data for the imposter class (e.g. “no aggression”, “no intrusion”, “no car accident”, “no gunshot”) as opposed to training data for the genuine class (“aggression”. “intrusion”. “car accident”, “gunshot”).

In cases where training set imbalance exists, the learned classifier tends to be biased toward the more common (majority) class, thereby introducing missed detections and generally a suboptimal system performance. Bootstrap resampling for creating classifier ensembles is a well-known technique, but suffers from noisy examples and outliers which can have a negative effect on the derived classifiers, especially for weak learners when class imbalance is high and bootstrapping is done only on the minority class, which leads to only few examples after bootstrapping.

Thus, it would be desirable to have a method and system for handling imbalanced datasets for classification and data fusion applications that offers reduced noise and bias due to class imbalance. This goal is met by embodiments of the present invention.

### SUMMARY

Various embodiments of the present invention provide sampling according to a combination of resampling and a supervised classification framework. Specifically, the adaptive bootstrap methodology is modified to resample according to a k-Nearest Neighbors (k-NN) sampling technique, and then to induce weak classifiers from the bootstrap samples. This is done iteratively and adapted according to the performance of the weak classifiers. Finally, a weighted combination scheme combines the weak classifiers into a strong classifier.

Embodiments of the present invention are advantageous in the domain of classification and data fusion, notably for classifier-based data fusion, which typically utilize regular classifiers (such as via Support Vector Machines) to perform data fusion (for example, classifier-based score level fusion for face recognition).

Embodiments of the invention improve the performance of supervised algorithms to address class imbalance issues in classification and data fusion frameworks. They provide bootstrapping aggregation that takes into account class imbalance in both the sampling and aggregation steps to iteratively improve the accuracy of every “weak” learner induced by the bootstrap samples.

The individual steps are detailed and illustrated herein.

Therefore, according to an embodiment of the present invention, there is provided a method for performing classification in an imbalanced dataset containing a plurality of majority class instances and a plurality of minority class instances, the method including: (a) training, by a data processor, a classifier on the imbalanced dataset: (b) estimating, by the data processor, an accuracy ACC for the classifier; (c) sampling, by the data processor, the plurality of majority class instances; (d) iterating, by the data processor, a predetermined number of times, during an iteration of which the data processor performs: (e) sampling to obtain a sample containing a plurality of majority class instances according to k-Nearest Neighbor weighting so that the ratio of a number of minority class instances to a number of majority class instances in the sample equals a predetermined ratio by computation on a previous iteration; (f) training a weak classifier on the sample obtained during the iteration; and (g) computing a ratio of a number of minority class instances to a number of majority class instances for a subsequent iteration; and (h) combining, by the data processor, a plurality of weak classifiers from a plurality of iterations into an ensemble aggregation corresponding to a strong classifier, wherein the combining is according to respective weights based on a function of accuracies of the weak classifiers.

In addition, according to another embodiment of the present invention, there is provided a system for performing classification in an imbalanced dataset containing a plurality of majority class instances and a plurality of minority class instances, the system including: (a) a data processor; and (b) a non-transitory storage device connected to the data processor, for storing executable instruction code, which executable instructions, when executed by the data processor, cause the processor to perform: (c) training a classifier on the imbalanced dataset; (d) estimating an accuracy ACC for the classifier; (e) sampling the plurality of majority class instances; (f) iterating a predetermined number of times, during an iteration of which: (g) sampling to obtain a sample containing a plurality of majority class instances according to k-Nearest Neighbor weighting so that the ratio of a number of minority class instances to a number of majority class instances in the sample equals a predetermined ratio by computation on a previous iteration; (h) training a weak classifier on the sample obtained during the iteration; and (i) computing a ratio of a number of minority class instances to a number of majority class instances for a subsequent iteration; and (j) combining a plurality of weak classifiers from a plurality of iterations into an ensemble aggregation corresponding to a strong classifier, wherein the combining is according to respective weights based on a function of accuracies of the weak classifiers.

Moreover, according to a further embodiment of the present invention, there is provided a computer data product for performing classification in an imbalanced dataset containing a plurality of majority class instances and a plurality of minority class instances, the computer data product including non-transitory data storage containing executable instruction code, which executable instructions, when executed by a data processor, cause the processor to perform: (a) training a classifier on the imbalanced dataset; (b) estimating an accuracy ACC for the classifier; (c) sampling the plurality of majority class instances; (d) iterating a predetermined number of times, during an iteration of which: (e) sampling to obtain a sample containing a plurality of majority class instances according to k-Nearest Neighbor weighting so that the ratio of a number of minority class instances to a number of majority class instances in the sample equals a predetermined ratio by computation on a previous iteration; (f) training a weak classifier on the sample obtained during the iteration; and (g) computing a ratio of a number of minority class instances to a number of majority class instances for a subsequent iteration; and (h) combining a plurality of weak classifiers from a plurality of iterations into an ensemble aggregation corresponding to a strong classifier, wherein the combining is according to respective weights based on a function of accuracies of the weak classifiers.

### BRIEF DESCRIPTION OF THE DRAWINGS

The subject matter disclosed may best be understood by reference to the following detailed description when read with the accompanying drawings in which:

FIG. 1 illustrates an example of weighted k nearest neighbor sampling with replacement, as utilized by various embodiments of the present invention.

FIG. 2 illustrates the steps and data flow for generating an ensemble aggregation according to an embodiment of the present invention.

For simplicity and clarity of illustration, reference numerals may be repeated to indicate corresponding or analogous elements.

### DETAILED DESCRIPTION

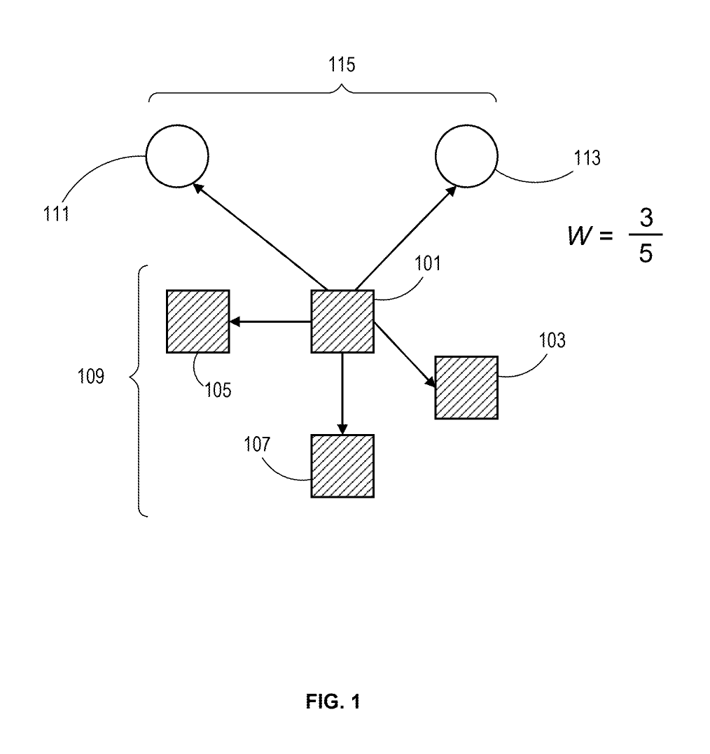

FIG. 1 illustrates a non-limiting example of weighted k nearest neighbor sampling with replacement, as utilized by various embodiments of the present invention. The weight is computed as the ratio of the number of sampled majority class instances to the total number of sampled nearest neighbors (i.e., k). In this non-limiting example, instances 101, 103, 105, and 107 are instances of a majority class 109. Instances 111 and 113 are instances of a minority class 115. Taking k=5, the k nearest neighbors of instance 101 are instances 103, 105, 107, 111, and 113, 3 of which are of majority class 109 (instances 103, 105, and 107). Hence, the weighted k nearest neighbor sampling for instance 101 is computed for this example as w=3/5.

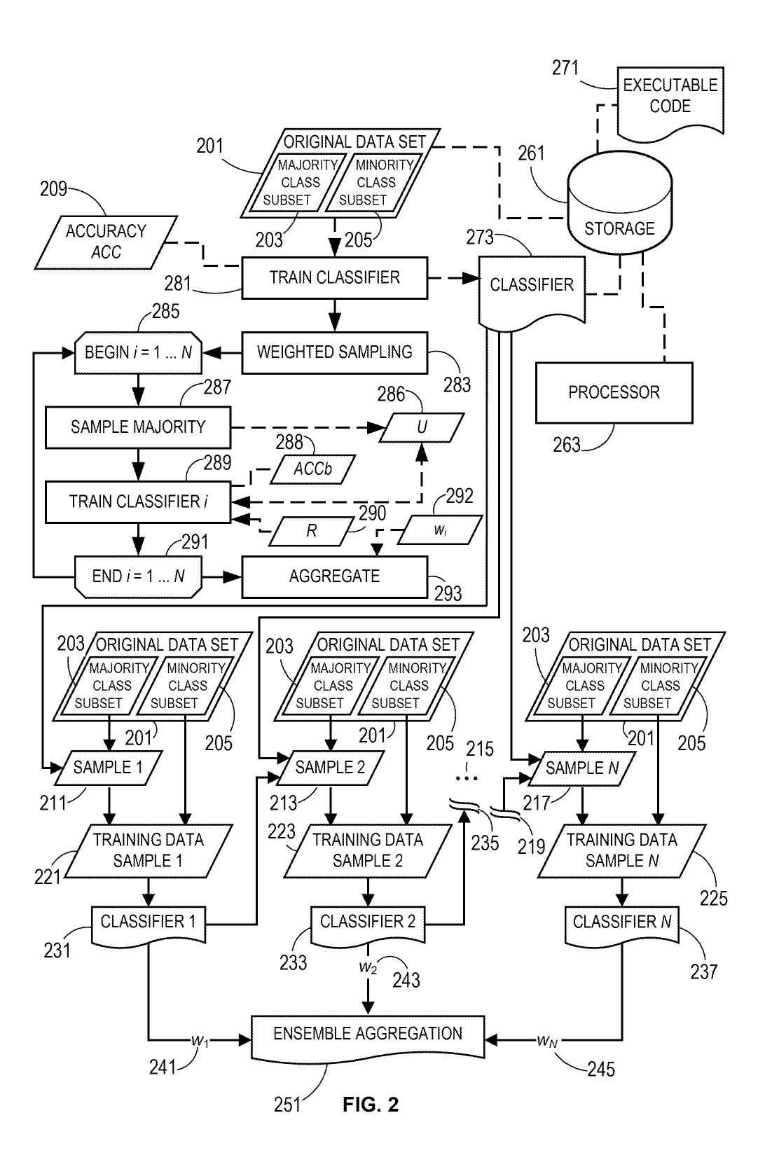

FIG. 2 illustrates steps and data flow for generating an ensemble aggregation 251 according to an embodiment of the present invention. In the following description of this embodiment, data processing operations are performed by a data processor 263 working from an original dataset 201 which is stored in a non-transitory data storage unit 261. Original dataset 201 includes a majority class subset 203 and a minority class subset 205. Also contained in non-transitory data storage unit 261 is machine-readable executable code 271 for data processor 263. Executable code 271 includes instructions for execution by data processor 263 to perform the operations described herein.

A classifier 273 is typically an algorithm or mathematical function that implements classification, identifying to which of a set of categories (sub-populations) a new observation belongs. In this embodiment, classifier 273 is also contained in non-transitory data storage unit 261 for implementation by data processor 263.

It is noted that data processor 263 is a logical device which may be implemented by one or more physical data processing devices. Likewise, non-transitory data storage unit 261 is also a virtual device which may be implemented by one or more physical data storage devices.

In a step 281 classifier 273 is trained on original dataset 201 and a classification accuracy ACC 209 is estimated for classifier 273. Then, in a step 283, weighted sampling with replacement is performed in majority class subset 203 in original dataset 201, as described previously and illustrated in FIG. 1.

A loop starting at a beginning point 285 through an ending point 291 (loop 285-291) is iterated for an index i=1 to N, where N is predetermined and typically takes values from 10 to 100. However, N can be determined in various ways, according to factors such as system performance, overall accuracy, and similar considerations. In a related embodiment of the present invention, N is predetermined according to a constraint on an upper bound of the standard deviation of the geometric mean of the final result.

In a step 287 within loop 285-291 for index i, majority class subset 205 instances are sampled according to the weighted bootstrapping scheme using weights obtained in step 283, so that the resulting ratio of the minority class instances to the majority class instances in the bootstrap sample equals a ratio U 286 predetermined by computation on the previous iteration (i−1). For i=1, U=1 by default.

In a step 289 a weak classifier denoted by index i is trained on the bootstrap sample obtained in step 287. Classification accuracy ACCb 288 of classifier i is estimated (e.g., using cross-validation). In a related embodiment, ratio U 286 of the number of minority class instances to majority class instances for the next iteration (i+1) is a function having the present iteration's value of U 286 (Uᵢ) as an argument, and is obtained by computation according to the following formula:

Uᵢ₊₁=c_{A}·Aᵢ+c_{U}·Uᵢ+c_{R}·R (Equation 1)

where weighting coefficients c_{A}, c_{U}, and C_{R} are non-negative numbers whose values depend on the significance of each term, normalized such that c_{A}+c_{U}+c_{R}=1. In the simplest case, they are equal, resulting in:

$${U}_{i + 1} = \frac{1}{3} \cdot {A}_{i} + \frac{1}{3} \cdot {U}_{i} + \frac{1}{3} \cdot R \qquad ( Equation 2 )$$

where:

$${A}_{i} = min ( 1 , \frac{ACCb}{( 1 - \frac{T}{100} ) \cdot ACC} )$$

with a parameter T which determines how much accuracy (in percent) that is allowed to be lost to every individual weak learner; and R is a random number 290 such that 0≦R≦1, appearing as an argument of a function for Uᵢ₊₁. It is also noted that the function (Equation 1) also has the accuracy ACC as an argument introduced via Aᵢ. By setting the parameter T, a user can have an accuracy of the base learner not less than T % of the original accuracy ACC. In principle, T can be considered as a trade-off between G-mean and accuracy measures of each base classifier. The higher T is set, the more accuracy loss can be tolerated. Setting T to a small value means that the resulting overall accuracy is desired to be close to the reference accuracy.

According to a related embodiment, U can either be a constant or start from a large number and progressively shrink if the generated weak classifiers produce good results in both overall accuracy and G-mean.

Data structures resulting from the iterations of loop 285-291 are illustrated in FIG. 2 as follows:

For the first iteration of loop 285-291 (i=1), a bootstrap sample 1 211 is obtained from majority class subset 203 by classifier 273. A training data sample 1 221 is obtained from sample 1 211 and minority class subset 205, and is used to train a classifier 1 231.

For the second iteration of loop 285-291 (i=2), a bootstrap sample 2 213 is obtained from majority class subset 203 by classifier 273 and classifier 1 231. A training data sample 2 223 is obtained from sample 2 213 and minority class subset 205, and is used to train a classifier 2 233. Classifier 2 233 is used in the third iteration 235 (i=3, not shown in detail). Iterations not shown (i=3, 4 . . . . , N−1) are indicated by an ellipsis 215.

For the final iteration of loop 285-291 (i=N), a bootstrap sample N 217 is obtained from majority class subset 203 by classifier 273 and a classifier N−1 219 (not shown in detail). A training data sample N 225 is obtained from a sample N 217 and minority class subset 205, and is used to train a classifier N 237.

After loop 285-291 completes, in a step 293 the weighted combining scheme is used to combine the N weak classifiers obtained from steps 287 and 289 (as iterated in loop 285-291) into ensemble aggregation 251 corresponding to a strong classifier. The contribution of each weak classifier is according to a weight computed as:

$${w}_{i} = 2 \cdot \frac{{acc}_{i}^{( - )} \cdot {acc}_{i}^{( + )}}{{acc}_{i}^{( - )} + {acc}_{i}^{( + )}} \qquad ( Equation 3 )$$

where accᵢ⁽⁻⁾ and accᵢ⁽⁺⁾ are the class-specific majority (“negative”) and minority (“positive”) accuracies for each weak classifier determined on the validation set that was unseen before.

Equation 2 above is for a 2-class case—a “negative” class and a “positive” class. In general, where there are L classes, the following multiclass relationship holds:

$$\frac{1}{{w}_{i}} = \frac{1}{L} ( \frac{1}{{acc}_{i}^{( 1 )}} + \frac{1}{{acc}_{i}^{( 2 )}} + … + \frac{1}{{acc}_{i}^{( L )}} ) \qquad ( Equation 4 )$$

where accᵢ^{(l)} is the class-specific accuracy for the l^{th} class (l=1, 2, . . . , L). For the case L=2, accᵢ⁽⁻⁾=accᵢ⁽¹⁾, and accᵢ⁽⁺⁾=accᵢ⁽²⁾, Equation 4 yields Equation 3.

In FIG. 2, there is a weight w₁ 241, a weight w₂ 243, and a weight w_{N} 245.

As noted previously, in a related embodiment of the present invention the above operations and computations are performed by a system having data processor 263 to perform the above-presented method by executing machine-readable executable code instructions 271 contained in a non-transitory data storage device 261, which instructions, when executed by data processor 263, cause data processor 263 to carry out the steps of the above-presented method.

In another related embodiment of the present invention, a computer product includes non-transitory data storage containing machine-readable executable code instructions 271, which instructions, when executed by a data processor, cause the data processor to carry out the steps of the above-presented method.

What is claimed is:

1. A method for performing classification in an imbalanced dataset containing a plurality of majority class instances and a plurality of minority class instances, the method comprising:
training, by a data processor, a classifier on the imbalanced dataset;
estimating, by the data processor, an accuracy ACC for the classifier;
sampling, by the data processor, the plurality of majority class instances:
iterating, by the data processor, a predetermined number of times, during an iteration of which the data processor performs:
sampling to obtain a sample containing a plurality of majority class instances according to k-Nearest Neighbor weighting so that the ratio of a number of minority class instances to a number of majority class instances in the sample equals a predetermined ratio by computation on a previous iteration;
training a weak classifier on the sample obtained during the iteration; and
computing a ratio of a number of minority class instances to a number of majority class instances for a subsequent iteration; and
combining, by the data processor, a plurality of weak classifiers from a plurality of iterations into an ensemble aggregation corresponding to a strong classifier, wherein the combining is according to respective weights based on a function of accuracies of the weak classifiers.

2. The method of claim 1, wherein the sampling is done with replacement.

3. The method of claim 1, wherein the number of times for the iterating is predetermined according to a constraint on an upper bound of a standard deviation of a geometric mean of a final result of the iterating.

4. The method of claim 1, wherein, for the first iteration, the ratio of the number of minority class instances to the number of majority class instances in the sample equals 1.

5. The method of claim 1, wherein, for a subsequent iteration, the ratio of the number of minority class instances to the number of majority class instances is a function having the corresponding ratio of the present iteration as an argument.

6. The method of claim 1, wherein, for a subsequent iteration, the ratio of the number of minority class instances to the number of majority class instances is a function having a random number as an argument.

7. The method of claim 1, wherein, for a subsequent iteration, the ratio of the number of minority class instances to the number of majority class instances is a function having the accuracy ACC as an argument.

8. A system for performing classification in an imbalanced dataset containing a plurality of majority class instances and a plurality of minority class instances, the system comprising:
a data processor; and
a non-transitory storage device connected to the data processor, for storing executable instruction code, which executable instructions, when executed by the data processor, cause the processor to perform:
training a classifier on the imbalanced dataset;
estimating an accuracy ACC for the classifier;
sampling the plurality of majority class instances;
iterating a predetermined number of times, during an iteration of which:
sampling to obtain a sample containing a plurality of majority class instances according to k-Nearest Neighbor weighting so that the ratio of a number of minority class instances to a number of majority class instances in the sample equals a predetermined ratio by computation on a previous iteration;
training a weak classifier on the sample obtained during the iteration; and
computing a ratio of a number of minority class instances to a number of majority class instances for a subsequent iteration; and
combining a plurality of weak classifiers from a plurality of iterations into an ensemble aggregation corresponding to a strong classifier, wherein the combining is according to respective weights based on a function of accuracies of the weak classifiers.

9. A computer data product for performing classification in an imbalanced dataset containing a plurality of majority class instances and a plurality of minority class instances, the computer data product comprising non-transitory data storage containing executable instruction code, which executable instructions, when executed by a data processor, cause the processor to perform:
training a classifier on the imbalanced dataset:
estimating an accuracy ACC for the classifier;
sampling the plurality of majority class instances;
iterating a predetermined number of times, during an iteration of which:
sampling to obtain a sample containing a plurality of majority class instances according to k-Nearest Neighbor weighting so that the ratio of a number of minority class instances to a number of majority class instances in the sample equals a predetermined ratio by computation on a previous iteration;
training a weak classifier on the sample obtained during the iteration; and
computing a ratio of a number of minority class instances to a number of majority class instances for a subsequent iteration; and
combining a plurality of weak classifiers from a plurality of iterations into an ensemble aggregation corresponding to a strong classifier, wherein the combining is according to respective weights based on a function of accuracies of the weak classifiers.
